(19) United States
(12) Patent Application Publication
(10) Pub. No.: US 2009/0303419 A1
(43) Pub. Date: Dec. 10, 2009

(54) LIQUID CRYSTAL DISPLAY DEVICE

(75) Inventor: Norio KOMA, Kotosu-gun (JP)

Correspondence Address: OLIFF & BERRIDGE, PLC, P.O. BOX 320850, ALEXANDRIA, VA, 22320-4850, US

(73) Assignee: Epson Imaging Devices Corporation, Azumino-shi (JP)

(21) Appl. No.: 12/467,569

(22) Filed: May 18, 2009

(30) Foreign Application Priority Data
Jun. 5, 2008 (JP) 2008-147788
Jul. 31, 2008 (JP) 2008-197472

(51) Int. Cl. G02F 1/1347; G02F 1/1335

(52) U.S. Cl. 349/74; 349/106

(57) ABSTRACT

Provided is a liquid crystal display device including: a first liquid crystal panel including a first liquid crystal layer; a second liquid crystal panel arranged to overlap the first liquid crystal panel and including a second liquid crystal layer; and color filters provided on the first liquid crystal panel, wherein color filters are not provided on the second liquid crystal panel, the first liquid crystal panel includes a plurality of first pixels, the second liquid crystal panel includes a plurality of second pixels, each of the first pixels of the first liquid crystal panel includes a plurality of sub pixels, and the second pixels are provided such that one second pixel corresponds to the plurality of sub pixels.

### BACKGROUND

1. Technical Field

The present invention relates to a liquid crystal display device and, more particularly, to a liquid crystal display device including a first liquid crystal panel and a second liquid crystal panel.

2. Related Art

In the related art, a liquid crystal display device including a first liquid crystal panel and a second crystal panel is known (for example, JP-A-2007-310161). In the liquid crystal display device disclosed in JP-A-2007-310161, since the first liquid crystal panel and the second liquid crystal panel are overlapped, contrast corresponding to a product of the contrast of the first liquid crystal panel and the contrast of the second liquid crystal panel can be obtained. In addition, since each of the first liquid crystal panel and the second liquid crystal panel includes a color filter, a color display can be realized in each of the first liquid crystal panel and the second liquid crystal panel.

However, in the liquid crystal display device described in JP-A-2007-310161, since the color filters are provided in both the first liquid crystal panel and the second liquid crystal panel, when the first liquid crystal panel and the second liquid crystal panel are overlapped, the amount of light passing through the first liquid crystal panel and the second liquid crystal panel is decreased. Accordingly, a displayed image darkens.

### SUMMARY

An advantage of some aspects of the invention is that it provides a liquid crystal display device capable of suppressing the darkening of a displayed image while increasing contrast.

According to a first aspect of the invention, there is provided a liquid crystal display device including: a first liquid crystal panel including a first liquid crystal layer; a second liquid crystal panel arranged to overlap the first liquid crystal panel and including a second liquid crystal layer; and color filters provided on the first liquid crystal panel, wherein color filters are not provided on the second liquid crystal panel, the first liquid crystal panel includes a plurality of first pixels, the second liquid crystal panel includes a plurality of second pixels, each of the first pixels of the first liquid crystal panel includes a plurality of sub pixels, and the second pixels are provided such that one second pixel corresponds to the plurality of sub pixels.

In the liquid crystal display device according to the first aspect, since the contrast corresponding to the product of the contrast of the first liquid crystal panel and the contrast of the second liquid crystal panel can be obtained by arranging the first liquid crystal panel and the second liquid crystal panel to overlap with each other, it is possible to increase the contrast of the liquid crystal display device, unlike a liquid crystal display device including only one liquid crystal panel. In addition, since the Color filters are provided on the surface of the first liquid crystal panel and the color filters are not provided on the surface of the second liquid crystal panel, unlike a case where the color filters are provided on both the first liquid crystal panel and the second liquid crystal panel, it is possible to suppress the darkening of an image when the first liquid crystal panel or the second liquid crystal panel is viewed from the front side thereof by the reduced number of color filters. In addition, since the pixel of the second liquid crystal panel is provided with respect to the plurality of sub pixels of the first liquid crystal panel, it is possible to reduce deterioration of an aperture ratio due to displacement generated when the panel is viewed in an oblique direction.

In the liquid crystal display device according to the first aspect, one second pixel may be arranged in correspondence with each first pixel including the plurality of sub pixels. By this configuration, since the color filters of red (R), green (G) and blue (B) are provided in the plurality of sub pixels, it is possible to display a color image by an additive color mixture. In addition, it is possible to obtain the contrast corresponding to the product of the contrast of the first pixel and the contrast of the second pixel by arranging one second pixel in every first pixel including the plurality of sub pixels.

In this case, among signal voltages applied to the plurality of sub pixels configuring each of the first pixels of the first liquid crystal panel, a signal voltage having maximum transmissivity may be applied to the second pixel of the second liquid crystal panel corresponding to each of the first pixels of the first liquid crystal panel. By this configuration, since, among the signal voltages applied to the sub pixels, the signal voltage having maximum transmissivity of the pixel is applied to the second pixel, it is possible to further suppress the darkening of the image.

In the liquid crystal display device in which a signal voltage having maximum transmissivity among the plurality of sub pixels is applied to the second pixel, if the transmissivity of the sub pixel having maximum transmissivity of the plurality of sub pixels configuring each of the first pixels is more than a predetermined threshold value, a signal voltage having maximum transmissivity may be applied to the second pixel corresponding to each of the first pixels, and, if the transmissivity of the sub pixel having maximum transmissivity of the plurality of sub pixels configuring each of the first pixels is equal to or less than the predetermined threshold value, a signal voltage having transmissivity corresponding to a sub pixel having maximum transmissivity of the sub pixels configuring each of the first pixels may be applied to the second pixel corresponding to each of the first pixels. By this configuration, if the transmissivity of the sub pixel is more than the predetermined threshold value, the signal voltage applied to the second pixel is the signal voltage having maximum transmissivity and, if the transmissivity of the sub pixel is equal to or less than the predetermined threshold value which is a dark display having an effect due to the overlapping of two liquid crystal panels, the signal voltage having transmissivity corresponding to the sub pixel having maximum transmissivity is applied, it is possible to efficiently increase the contrast.

The liquid crystal display device according to the first aspect may further include a first polarization plate interposed between the first liquid crystal layer and the second liquid crystal layer, a second polarization plate provided on the surface of the first liquid crystal layer at side opposite to the first polarization plate side, and a third polarization plate provided on the surface of the second liquid crystal layer at side opposite to the first polarization plate side, and a polarization degree of at least one of the first polarization plate, the second polarization plate and the third polarization plate may be 99% or less. By this configuration, since the transmissivity is improved compared with a polarization plate having a polarization degree exceeding 99%, it is possible to further suppress darkening of the image.

In this case, a first retardation film may be disposed in at least one of spaces between the first liquid crystal layer and the second polarization plate and between the second liquid crystal layer and the third polarization plate. By this configuration, for example, it is known that a viewing angle is increased by using an A plate or a C plate as the first retardation film. The viewing angle of the liquid crystal display device can be increased by using the A plate or the C plate as the first retardation film.

The liquid crystal display device in which the first polarization plate is provided between the first liquid crystal layer and the second liquid crystal layer may further include a first substrate interposed between the first liquid crystal layer and the first polarization plate, and a second substrate interposed between the second liquid crystal layer and the first polarization plate, the first substrate and the second substrate may protrude from the first liquid crystal layer and the second liquid crystal layer in plan view, and the first polarization plate may be formed on the substantially whole surfaces of the first substrate and the second substrate. By this configuration, it is possible to easily increase mechanical strength when the first substrate, the second substrate and the first polarization plate are put together.

In the liquid crystal display device in which the first polarization plate is provided between the first liquid crystal layer and the second liquid crystal layer, the first polarization plate may include a pair of polarization plates and a second retardation film interposed between the pair of polarization plates. By this configuration, it is possible to separately set the polarization axes of the pair of polarization plates and adjust the viewing angle.

In this case, the second retardation film may be a ½ wavelength plate. By this configuration, it is possible to change the polarization axis of the light incident from one of the pair of polarization plate to the ½ wavelength plate to a desired polarization axis such that the light is emitted to the other of the pair of polarization plates.

In the liquid crystal display device in which the first polarization plate may include the pair of polarization plates and the second retardation film interposed between the pair of polarization plates, the polarization axes of the pair of polarization plates form an angle of 45° with each other, and the second retardation film rotates the polarization of light incident from one of the pair of polarization plates by 45° and emits the light to the other polarization plate. By this configuration, it is possible to increase the viewing angle over omnidirection.

The liquid crystal display device according to the first aspect may further include a first polarization plate provided between the first liquid crystal layer and the second liquid crystal layer, a first substrate provided between the first liquid crystal layer and the first polarization plate, and a second substrate provided between the second liquid crystal layer and the first polarization plate, a first pixel electrode and a common electrode may be provided on the surface of the first substrate at the first liquid crystal layer side, and a second pixel electrode and a second common electrode may be provided on the surface of the second substrate at the second liquid crystal layer side. By this configuration, since the liquid crystal display device of an in-plane switching (IFS) system or a fringe field switching (FFS) system can be formed, it is possible to increase the viewing angle. That is, since an electric field is applied to liquid crystal molecules in a lateral (oblique) direction in the IPS system or the FFS system, a variation of the liquid crystal molecules in a longitudinal direction does not occur unlike a system for applying an electric field in the longitudinal direction. Thus, it is possible to increase the viewing angle.

The liquid crystal display device according to the first aspect may further include a first polarization plate provided between the first liquid crystal layer and the second liquid crystal layer, a first substrate provided between the first liquid crystal layer and the first polarization plate, a first counter substrate disposed to face the first substrate, a second substrate provided between the second liquid crystal layer and the first polarization plate, and a second counter substrate disposed to face the second substrate, a first pixel electrode may be provided on the surface of the first substrate at the first liquid crystal layer side, a first common electrode may be provided on the surface of the first counter substrate to face the first pixel electrode with the first liquid crystal layer interposed therebetween, and a second pixel electrode and a second common electrode may be provided on the surface of the second substrate at the second liquid crystal layer side. By this configuration, if the liquid crystal included in the second liquid crystal layer is the OCB liquid crystal in which liquid crystal molecules are arranged in a bow state after a voltage for phase-transitioning the liquid crystal is applied, since a variation in the alignment of the liquid crystal molecules is accelerated by the bow form, it is possible to configure a liquid crystal display device having a rapid response speed.

In the liquid crystal display device according to the first aspect, a distance d between the first liquid crystal layer and the second liquid crystal layer may be configured to satisfy a relationship of d≦p/0.33 when a pixel pitch of the second pixels is p. By this configuration, when the predetermined first pixel of the first liquid crystal panel is viewed in an oblique direction, it is possible to suppress leakage of the light from the second pixel adjacent to the second pixel of the second liquid crystal panel corresponding to the predetermined first pixel from the predetermined first pixel of the first liquid crystal panel.

In the liquid crystal display device according to the first aspect, the distance d between the first liquid crystal layer and the second liquid crystal layer may be configured to satisfy a relationship of d≦p/0.44. By this configuration, for example, even when the first liquid crystal panel shifted in a left (right) direction is viewed by the right eye (left eye) of an observer, it is possible to suppress leakage of the light from the second pixel adjacent to the second pixel of the second liquid crystal panel corresponding to the predetermined first pixel from the predetermined first pixel of the first liquid crystal panel.

In the liquid crystal display device according to a second aspect of the invention, there is provided a liquid crystal display device including: a first liquid crystal panel including a first liquid crystal layer; a second liquid crystal panel arranged to overlap the first liquid crystal panel and including a second liquid crystal layer; and color filters provided on the first liquid crystal panel, wherein color filters are not provided on the second liquid crystal panel, the first liquid crystal panel includes a plurality of first pixels, the second liquid crystal panel includes a plurality of second pixels, the second pixels are provided in correspondence with the first pixels, and a distance d between the first liquid crystal layer and the second liquid crystal layer is configured to satisfy a relationship of d≦p/0.33 when a pixel pitch of the second pixels is p.

In the liquid crystal display device according to the second aspect, since the contrast corresponding to the product of the contrast of the first liquid crystal panel and the contrast of the second liquid crystal panel can be obtained by arranging the first liquid crystal panel and the second liquid crystal panel to overlap with each other, it is possible to increase the contrast of the liquid crystal display device, unlike a liquid crystal display device including only one liquid crystal panel. In addition, since the color filters are provided on the surface of the first liquid crystal panel and the color filters are not provided on the surface of the second liquid crystal panel, unlike a case where the color filters are provided on both the first liquid crystal panel and the second liquid crystal panel, it is possible to suppress the darkening of an image when the first liquid crystal panel or the second liquid crystal panel is viewed from the front side thereof by the reduced number of color filters. In addition, since the pixel of the second liquid crystal panel is provided with respect to the plurality of sub pixels of the first liquid crystal panel, it is possible to reduce deterioration of an aperture ratio due to displacement generated when the panel is viewed in an oblique direction. In addition, since the distance d between the first liquid crystal layer and the second liquid crystal layer may be configured to satisfy a relationship of d≦p/0.33 when the pixel pitch of the second pixels is p, when the predetermined first pixel of the first liquid crystal panel is viewed in an oblique direction, it is possible to suppress leakage of the light from the second pixel adjacent to the second pixel of the second liquid crystal panel corresponding to the predetermined first pixel from the predetermined first pixel of the first liquid crystal panel.

In the liquid crystal display device according to the second aspect, the distance d between the first liquid crystal layer and the second liquid crystal layer may be configured to satisfy a relationship of d≦p/0.44. By this configuration, for example, even when the first liquid crystal panel shifted in a left (right) direction is viewed by the right eye (left eye) of an observer, it is possible to suppress leakage of the light from the second pixel adjacent to the second pixel of the second liquid crystal panel corresponding to the predetermined first pixel from the predetermined first pixel of the first liquid crystal panel.

### BRIEF DESCRIPTION OF THE DRAWINGS

The invention will be described with reference to the accompanying drawings, wherein like numbers reference like elements.

FIG. 1 is a plan view of a liquid crystal display device according to a first embodiment of the invention.

FIG. 2 is a cross-sectional view of the liquid crystal display device according to the first embodiment of the invention.

FIG. 3 is an enlarged cross-sectional view of the liquid crystal display device of FIG. 2.

FIG. 4 is a view explaining a signal voltage determination circuit according to the first embodiment of the invention.

FIG. 5 is a plan view of a sub pixel according to the first embodiment of the invention.

FIG. 6 is a plan view of a pixel according to the first embodiment of the invention.

FIG. 7 is a cross-sectional view taken along line VII-VII of FIG. 5.

FIG. 8 is a view explaining a transmission axis of a polarization plate and a rubbing direction of an alignment film of the liquid crystal display device according to the first embodiment of the invention.

FIG. 9 is a plan view of a sub pixel for explaining the operation of a liquid crystal display device of a fringe-field switching (FFS) system according to the first embodiment of the invention.

FIG. 10 is a plan view of a sub pixel for explaining the operation of the liquid crystal display device of the FFS system according to the first embodiment of the invention.

FIG. 11 is a cross-sectional view of a sub pixel for explaining the operation of the FFS system according to the first embodiment of the invention.

FIG. 12 is a cross-sectional view of a sub pixel for explaining the operation of the FFS system according to the first embodiment of the invention.

FIG. 13 is a view showing a relationship between an applied voltage and a ratio of transmission light intensity to maximum transmission light intensity according to the first embodiment of the invention.

FIG. 14 is a view showing a simulation result of contrast in a vertical direction of a liquid crystal panel.

FIG. 15 is a view showing a simulation result of contrast in a horizontal direction of the liquid crystal panel.

FIG. 16 is a plan view of a sub pixel of a liquid crystal display device according to a second embodiment of the invention.

FIG. 17 is a cross-sectional view of a liquid crystal display device according to a third embodiment of the invention.

FIG. 18 is a plan view of a sub pixel of a liquid crystal display device according to a fourth embodiment of the invention.

FIG. 19 is a cross-sectional view of a liquid crystal display device according to a fifth embodiment of the invention.

FIG. 20 is a detailed cross-sectional view of the liquid crystal display device according to the fifth embodiment of the invention.

FIG. 21 is a view explaining a transmission axis of a polarization plate and a rubbing direction of an alignment film of the liquid crystal display device according to the fifth embodiment of the invention.

FIG. 22 is a cross-sectional view of a sub pixel for explaining the operation of OCB liquid crystal according to the fifth embodiment of the invention.

FIG. 23 is a cross-sectional view of a sub pixel for explaining the operation of OCB liquid crystal according to the fifth embodiment of the invention.

FIG. 24 is a view showing a relationship between an applied voltage and a transmission light intensity ratio according to the fifth embodiment of the invention.

FIG. 25 is a cross-sectional view of a liquid crystal display device according to a sixth embodiment of the invention.

FIG. 26 is a view explaining a transmission axis of a polarization plate and a rubbing direction of an alignment film of the liquid crystal display device according to the sixth embodiment of the invention.

FIG. 27 is a view showing a positional relationship between two liquid crystal panels according to a seventh embodiment of the invention.

FIG. 28 is a view explaining a positional relationship between an observer and the liquid crystal display device according to the seventh embodiment of the invention.

### DESCRIPTION OF EXEMPLARY EMBODIMENTS

Hereinafter, the embodiments of the invention will be described with reference to the accompanying drawings.

### First Embodiment

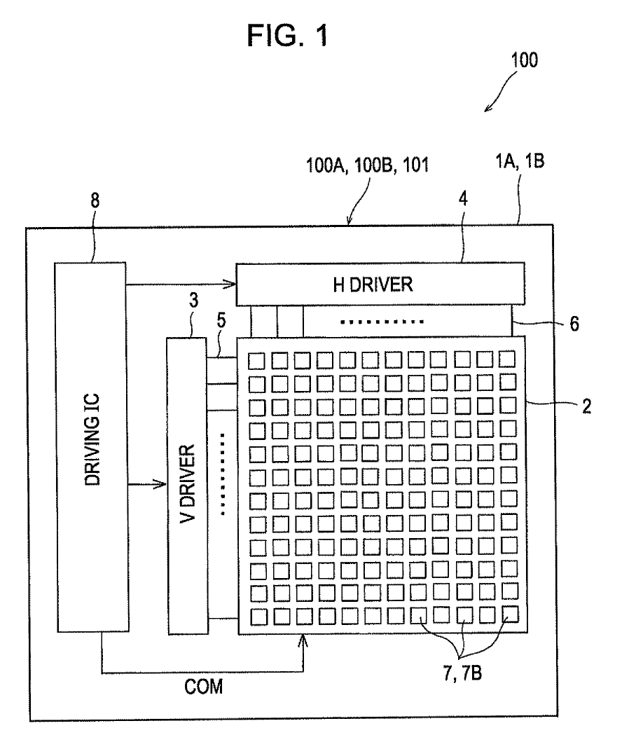

FIG. 1 is a plan view of a liquid crystal display device according to a first embodiment of the invention.

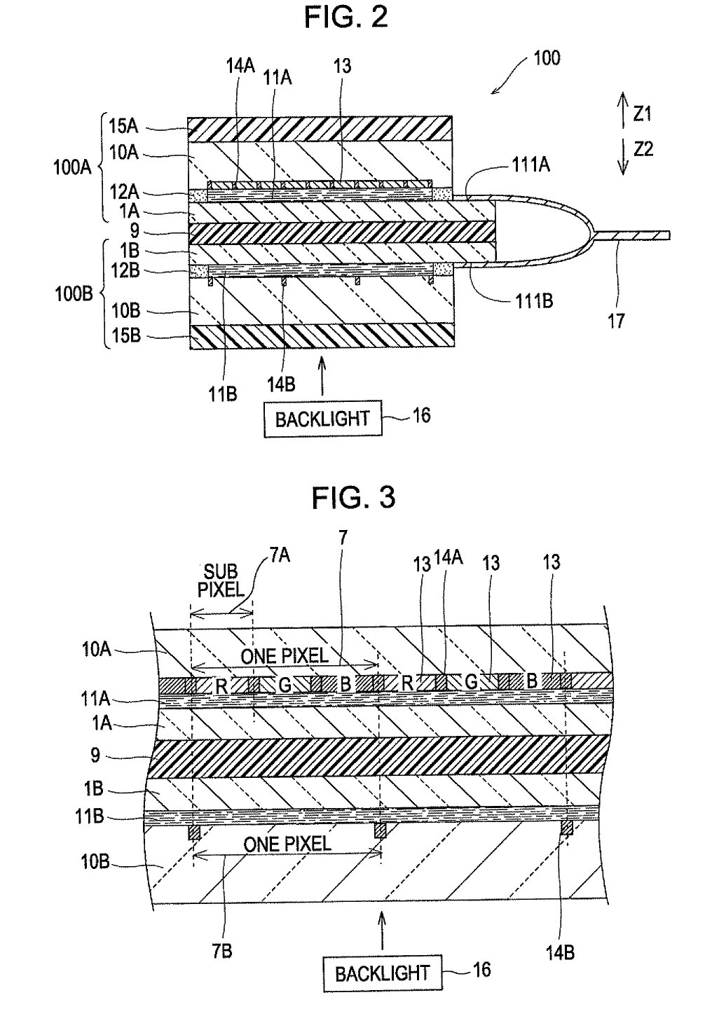

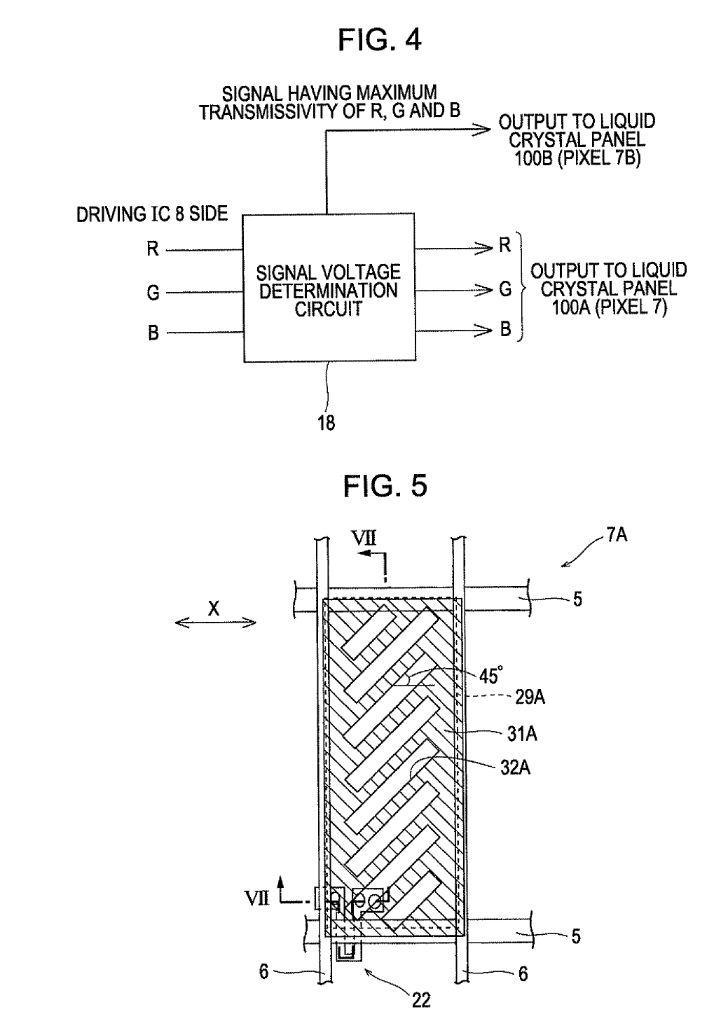

FIG. 2 is a cross-sectional view of the liquid crystal display device according to the first embodiment of the invention. FIG. 3 is an enlarged cross-sectional view of the liquid crystal display device of FIG. 2. FIG. 4 is a view explaining a signal voltage determination circuit according to the first embodiment of the invention. First, the configuration of the liquid crystal display device 100 according to the first embodiment of the invention will be described with reference to FIGS. 1 to 4.

The liquid crystal display device 100 according to the first embodiment is configured by overlapping a liquid crystal panel 100A and a liquid crystal panel 100B, as shown in FIG. 2. In addition, the liquid crystal panel 100A and the liquid crystal panel 1003 are examples of a “first liquid crystal panel” and a “second liquid crystal panel” of the invention, respectively. In the liquid crystal panel 100A (100B), as shown in FIG. 1, a display unit 2, a V driver 3 and a H driver 4 are provided on a substrate 1A (1B) formed of glass. The V driver 3 and the H driver 4 are connected with a plurality of gate lines 5 and a plurality of data lines 6, respectively. Pixels 7 (73) are arranged at positions where the gate lines 5 and the data lines 6 intersect. In addition, the pixels 7 and 7B are examples of “first pixels” and “second pixels” of the invention, respectively. A driving IC 8 is provided on the substrate 1A (1B) and the V driver 3 and the H driver 4 are connected to the driving IC 8. The display unit 2 is connected to the driving IC 8 such that a common potential (COM) is supplied to a common electrode 31A (31).

In the first embodiment, as shown in FIG. 2, the liquid crystal display device 100 is configured by overlapping the liquid crystal panel 100A (substrate 1A) and the liquid crystal panel 100B (substrate 1B) with a polarization plate 9 having a thickness of about 0.15 mm interposed therebetween, and the polarization plate 9 is formed on the substantially whole surface of the substrate 1A and the substrate 1B. In addition, the polarization plate 9 is an example of a “first polarization plate” of the invention. The thickness of the polarization plate 9 is set to be less than that of a polarization plate 15A and that of a polarization plate 15B. In addition, in the first embodiment, a polarization degree of at least one of the polarization plate 9, the polarization plate 15A and the polarization plate 15B is set to 99% or less. The polarization plate 9 and the substrate 1A are adhered by a resin adhesive and the polarization plate 9 and the substrate 1B are adhered by a resin adhesive.

As shown in FIG. 2, in the liquid crystal panel 100A, a counter substrate 10A is provided to face the substrate 1A having a thickness of about 0.15 mm, and a liquid crystal layer 11A is interposed between the substrate 1A and the counter substrate 10A. In addition, the substrate 1A and the counter substrate 10A are examples of a “first substrate” and a “first counter substrate” of the invention, respectively. The liquid crystal layer 11A is an example of a “first liquid crystal layer” of the invention, The thickness of the substrate 1A is set to be less than that of the counter substrate 10A. The liquid crystal layer 11A is sealed between the substrate 1A and the counter substrate 10A, by a seal 12A for adhering the substrate 1A and the counter substrate 10A.

In the first embodiment, as shown in FIG. 3, color filters 13 of red (R), green (G) and blue (B) are formed between the counter substrate 10A and the liquid crystal layer 11A. In addition, color filters are not provided in a liquid crystal layer 11B. On the surface of the counter substrate 10A, a black matrix 14A is provided to divide the color filters 13 of red (R), green (G) and blue (B). In addition, one pixel 7 includes three sub pixels 7A including a sub pixel 7A having a color filter of red (R), a sub pixel 7A having a color filter 13 of green (G), and a sub pixel 7A having a color filter 13 of blue (B).

Alignment films (not shown) are formed on the side of the substrate 1A and the side of the color filters 13 of the liquid crystal layer 11A. As shown in FIG. 2, the polarization plate 15A is provided on the surface of the counter substrate 10A at the side opposite to the liquid crystal layer 11A. The polarization plate 15A is an example of a “second polarization plate” of the invention.

As shown in FIG. 2, in the liquid crystal panel 100B, a counter substrate 10B is provided to face the substrate 1B having a thickness of about 0.15 mm, and a liquid crystal layer 11B is interposed between the substrate 1B and the counter substrate 10B. In addition, the substrate 1B and the counter substrate 10B are examples of a second substrate and a “second counter substrate” of the invention, respectively. The liquid crystal layer 11B is an example of a “second liquid crystal layer” of the invention. The thickness of the substrate 1B is set to be less than that of the counter substrate 10B. The liquid crystal layer 11B is sealed between the substrate 1B and the counter substrate 10B, by a seal 12B for adhering the substrate 1B and the counter substrate 10B.

As shown in FIG. 3, a black matrix 14B is formed between the counter substrate 10B and the liquid crystal layer 11B. In the first embodiment, the black matrix 14B of the liquid crystal panel 100B is arranged such that one pixel 7B of the liquid crystal panel 100B corresponds to three sub pixels 7A of the liquid crystal panel 100A. Accordingly, the resolution of the liquid crystal panel 100B is lower than that of the liquid crystal panel 100A.

As shown in FIG. 4, a signal voltage determination circuit 18 is provided between a driving IC 8 and the pixel 7. The signal voltage determination circuit 18 has a function for applying signal voltages of red (R), green (G) and blue (B) to the three sub pixels 7A of the pixel 7 of the liquid crystal panel 100A and applying a signal voltage having maximum transmissivity of the signal voltages applied to the three sub pixels 7A to the pixel 7B of the liquid crystal panel 100B.

Alignment films (not shown) are formed on the side of the counter substrate 10B and the side of the black matrix 14B of the liquid crystal layer 11B. As shown in FIG. 2, the polarization plate 15B is provided on the surface of the counter substrate 10B at the side opposite to the liquid crystal layer 11B. The polarization plate 15N is an example of a “third polarization plate” of the invention.

As described above, the substrate 1A having the thickness of about 0.15 mm, the polarization plate 9 having the thickness of about 0.15 mm and the substrate 13 having the thickness of about 0.15 mm are interposed between the liquid crystal layer 11A and the liquid crystal layer 11B, and a gap between the liquid crystal layer 11A and the liquid crystal layer 11B is about 0.45 mm.

As shown in FIG. 2, in the liquid crystal panel 100A, the substrate 1A, the liquid crystal layer 11A, the black matrix 14A (color filters 13), the counter substrate 10A and the polarization plate 15A are sequentially formed toward a Z1 direction. In contrast, in the liquid crystal panel 100B, the substrate 1B, the liquid crystal layer 11B, the black matrix 14B, the counter substrate 10B and the polarization plate 15B are sequentially formed toward a Z2 direction opposite to the Z1 direction. A backlight 16 is provided below the liquid crystal panel 100B.

In the first embodiment, as shown in FIG. 2, the substrate 1A and the substrate 1B have portions 111A and 111B protruding from one end of the counter substrate 10A and one end of the counter substrate 10B in plan view, respectively. A common flexible printed circuit board (FPC) 17 connected to the protruding portions 111A and 111B of the substrate 1A and the substrate 1B. Accordingly, the same signal is sent to the liquid crystal panel 100A and the liquid crystal panel 100B. In addition, the FPC 17 is divided into two lines at the side in which the liquid crystal panel 100A and the liquid crystal panel 100B are connected and is collected as one at the side opposite to the side in which the liquid crystal panel 100A and the liquid crystal panel 100B are connected.

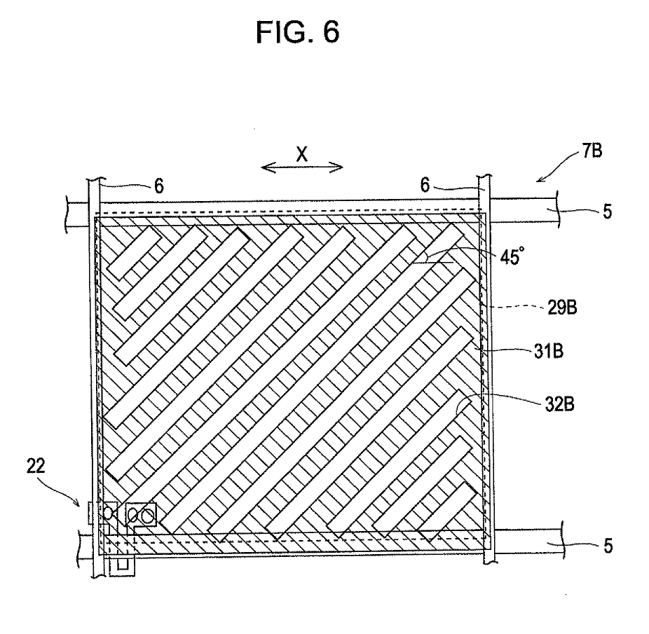

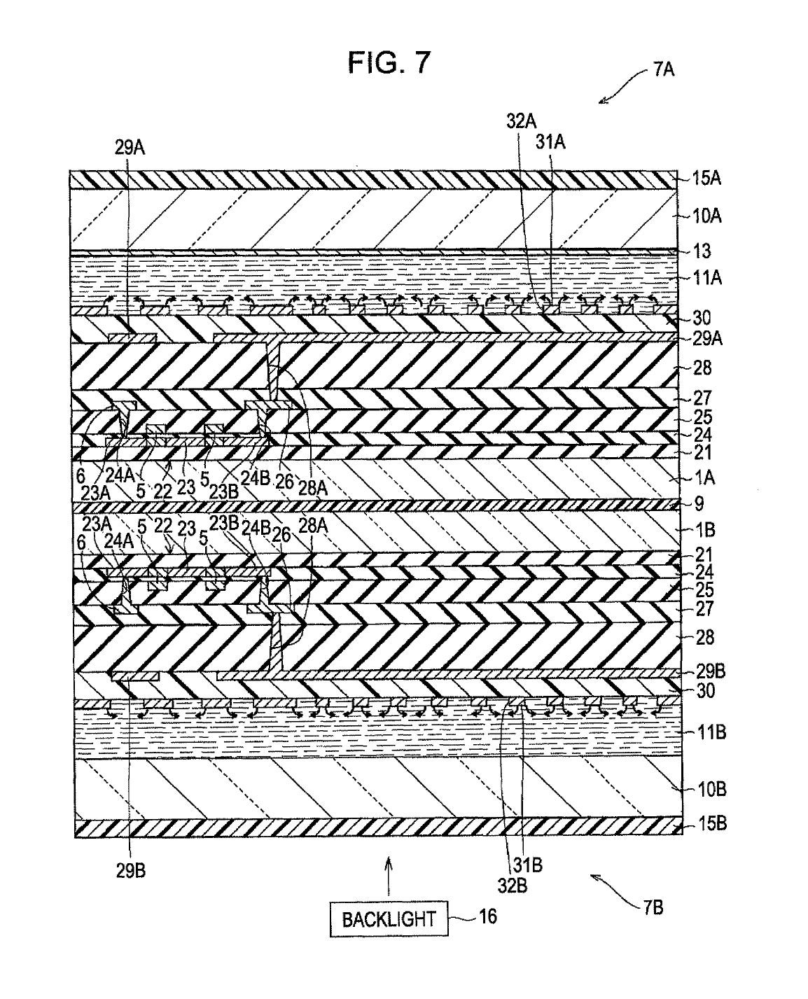

FIG. 5 is a plan view of a sub pixel according to the first embodiment of the invention. FIG. 6 is a plan view of a pixel according to the first embodiment of the invention, FIG. 7 is a cross-sectional view taken along line VII-VII of FIG. 5. Next, the detailed configuration of the sub pixel 7A (pixel 7B) according to the first embodiment of the invention will be described with reference to FIGS. 5 to 7.

As shown in FIG. 7, a buffer film 21 is formed on the surface of the substrate 1A. This buffer film 21 is formed of silicon oxide, silicon nitride or the like. In addition, an active layer 23 is formed in a region in which a pixel selection thin-film transistor (TFT) 22 is formed on the surface of the buffer film 21. This active layer 23 is formed of polysilicon or the like. In addition, an insulating film 24 is formed on the surface of the buffer film 21 to cover the active layer 23. A portion of the insulating film 24 located at the active layer 23 functions as a gate insulating film. This insulating film 24 is formed of silicon oxide or silicon nitride. In addition, a gate line 5 functioning as a gate electrode is formed on the surface of the insulating film 24 functioning as the gate insulating film. This gate line 5 is formed of metal or the like including chrome or molybdenum. In addition, an interlayer insulating film 25 is formed on the surfaces of the insulating film 24 and the gate line 5.

A contact hole 24A for exposing a source region 23A of the active layer 23 and a contact hole 24B for exposing a drain region 23B are formed in the interlayer insulating film 25. In addition, a data line 6 is formed to be connected to the source region 23A via the contact hole 24A and to be extended on the surface of the interlayer insulating film 25. This data line 6 is formed of metal including aluminum, an aluminum alloy or the like. In addition, a drain electrode 26 is formed to be connected to the drain region 23B via the contact hole 24B and to be extended on the surface of the interlayer insulating film 25. This drain electrode 26 is formed of metal including aluminum, an aluminum alloy or the like. A passivation film 27 formed of an insulating film is formed on the surfaces of the drain electrode 26 and the interlayer insulating film 25. In addition, the TFT 22 includes the active layer 23 including the source region 23A and the drain region 23B, the drain electrode 26, and the gate electrode (gate line 5). This TFT 22 is connected to a pixel electrode 29A.

A planarization film 28 formed of an insulating film is formed on the surface of the passivation film 27. A contact hole 28A is formed in the passivation film 27 and the planarization film 28. This contact hole 28A is formed for exposing the drain electrode 26. The pixel electrode 29A (29B) formed of a transparent electrode such as indium tin oxide (ITO) is formed on the surface of the planarization film 28. In addition, the pixel electrode 29A (29B) is an example of a “first (second) pixel electrode” of the invention. This pixel electrode 29A (29B) is connected to the drain electrode 26 via the contact hole 28A, A voltage according to a display signal is applied to this pixel electrode 29A (29B).

An insulating film 30 formed of silicon nitride or the like is formed on the surface of the pixel electrode 29A (29B). A common electrode 31A (31B) formed of a transparent electrode such as ITO is formed on the surface of the insulating film 30. In addition, the common electrode 31A (31B) is an example of a “first (second) common electrode” of the invention. As shown in FIG. 2, the liquid crystal layer 11A (11B), the color filters 13, the counter substrate 10A (10B) and the polarization plate 15A (15B) are laminated on the surface of the common electrode 31A (31B).

As described above, in the first embodiment, the pixel electrode 29A (29B) and the common electrode 31A (31B) do not face each other with the liquid crystal layer 11A interposed therebetween and are provided on the substrate 1A (1B).

As shown in FIG. 5, slits 32A are provided in the common electrode 31A of the sub pixel 7A so as to form an angle of 45° with an X direction in which the gate line 5 extends. As shown in FIG. 6, slits 321 which form an angle of 45° with the x direction are provided in the common electrode 31B of the pixel 7B. Accordingly, when the sub pixel 7A and the pixel 7B are put together as shown in FIG. 7, the direction of the slits 32A of the sub pixel 7A and the direction of the slits 32B of the pixel 7B cross each other in plan view. The pixel 7B has an area corresponding to the area of three sub pixels 7A.

As shown in FIG. 7, the backlight 16 is provided to face the pixel 7B (liquid crystal panel 100B). The backlight 16 emits light from the liquid crystal panel 100B to the liquid crystal panel 100A.

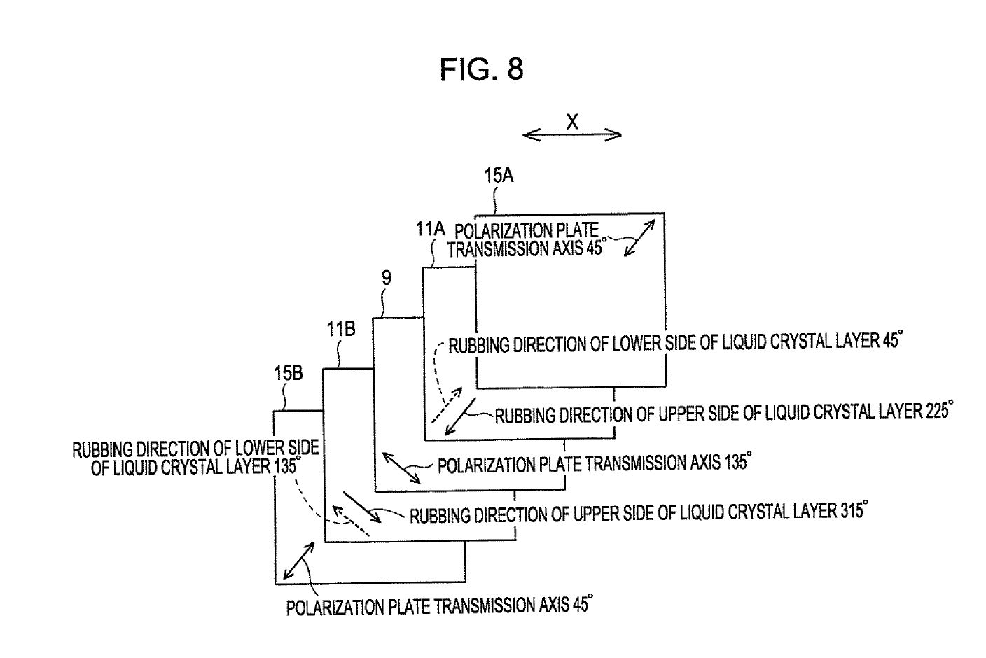

FIG. 8 is a view explaining a transmission axis of the polarization plate and a rubbing direction of the alignment film of the liquid crystal display device according to the first embodiment of the invention. Next, the direction of the transmission axis of the polarization plate and the rubbing direction of the liquid crystal layer (alignment film) of the liquid crystal display device 100 will be described with reference to FIG. 8.

As shown in FIG. 8, the transmission axis of the polarization plate 15A provided on the surface of the liquid crystal layer 11A forms 45° with the X direction. The rubbing angles of one side (upper side) and the other side (lower side) of the alignment film provided with the liquid crystal layer 11A interposed therebetween are 225° and 45°, respectively. The transmission axis of the polarization plate 9 is 135° so as to be perpendicular to the transmission axis of the polarization plate 15A. In addition, the rubbing angles of one side (upper side) and the other side (lower side) of the alignment film provided with the liquid crystal layer 113 interposed therebetween are 315° and 135°, respectively. The transmission axis of the polarization plate 15B is 45° so as to be perpendicular to the transmission axis of the polarization plate 9.

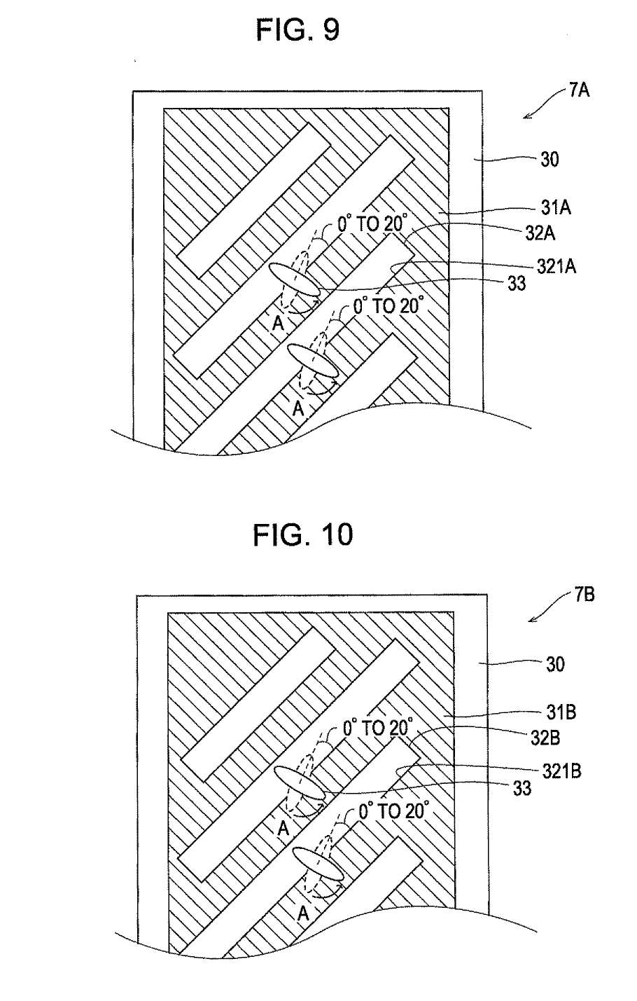

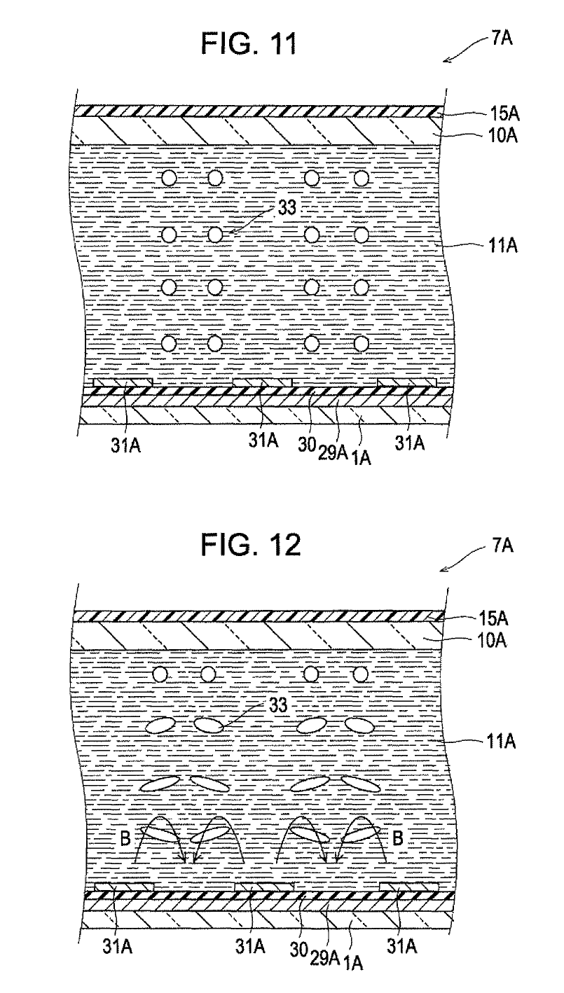

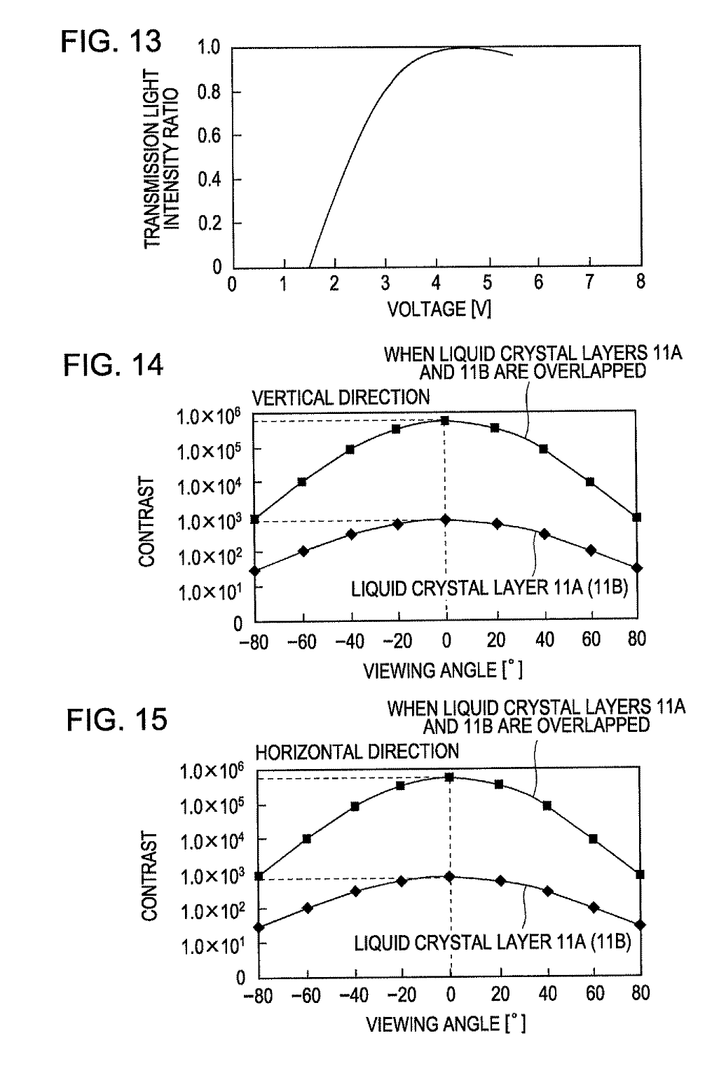

FIGS. 9 and 10 are plan views of a sub pixel for explaining the operation of a liquid crystal display device of a fringe-field switching (FFS) system according to the first embodiment of the invention. FIGS. 11 and 12 are cross-sectional views of a sub pixel for explaining the operation of the FFS system according to the first embodiment of the invention. FIG. 13 is a view showing a relationship between an applied voltage and a ratio of transmission light intensity to maximum transmission light intensity according to the first embodiment of the invention. Next, the operation of the liquid crystal display device 100 of the FFS system according to the first embodiment of the invention will be described with reference to FIGS. 9 to 13. FIGS. 11 and 12 are obtained by simplifying the configuration of the sub pixel 7A shown in FIG. 7, and show only the substrate 1A, the pixel electrode 29A, the insulating film 30, the common electrode 31A, the counter substrate 10A, the polarization plate 15A and liquid crystal 33.

As the FFS system, as shown in FIGS. 9 and 10, when a voltage is not applied to the liquid crystal 33, the liquid crystal 33 are aligned to cross the long sides 321A of the slits 32A and the long sides 321B of the slits 32B to form an angle of about 0° to 20° in a direction denoted by an arrow A (counterclockwise direction) (the liquid crystal 33 denoted by dotted lines in FIGS. 9 and 10). That is, the rubbing direction of the alignment film (not shown) forms an angle of about 0° to 20° with the long sides 321A of the slits 32A (the long sides 321B of the slits 32B) in the direction denoted by the arrow A. When the voltage is not applied to the liquid crystal 33, as shown in FIG. 11, whole liquid crystal 33 is aligned in the same direction (the direction which forms an angle of 0° to 20° in the direction denoted by the arrow A, shown in FIGS. 9 and 10). The liquid crystal 33 may be positive liquid crystal (liquid crystal which becomes parallel to an electric field) or negative liquid (liquid crystal which becomes perpendicular to the electric field). Since the liquid crystal panel 100B is arranged to be reversed against the liquid crystal panel 100A, the liquid crystal 33 is aligned such that the direction of the initial alignment (alignment when the voltage is not applied to the liquid crystal 33) of the liquid crystal 33 of the liquid crystal panel 100A and the direction of the initial alignment (alignment when the voltage is not applied to the liquid crystal 33) of the liquid crystal 33 of the liquid crystal panel 33 cross each other.

Next, when the voltage is applied to the liquid crystal 33, as shown in FIG. 12, an electric field is generated between the pixel electrode 29A and the common electrode 31A (an arrow B of FIG. 12). Accordingly, as shown in FIGS. 9 and 10, the liquid crystal 33 rotates in the direction denoted by the arrow A in the plane parallel to the pixel electrode 29A. In addition, since the liquid crystal panel 100B are arranged to be reversed against the liquid crystal panel 100A, in the actual rotation direction of the liquid crystal 33, the direction of the liquid crystal 33 of the liquid crystal panel 100A and the direction of the liquid crystal 33 of the liquid crystal panel 100B are opposite to each other. As shown in FIG. 13, the transmission light intensity ratio of the sub pixel 7A is increased by applying the voltage to the liquid crystal 33. For example, in the example of FIG. 13, the transmission light intensity ratio of the sub pixel 7A becomes about 1.0 (maximum transmission light intensity) by applying a voltage of about 4.5 V to the liquid crystal 33.

In the first embodiment, if the voltage-transmission light intensity characteristic of the liquid crystal panel 100A and the voltage-transmission light intensity characteristic of the liquid crystal panel 100B are equal, by the signal voltage determination circuit 18 shown in FIG. 4, the signal voltages of red (R), green (G) and blue (B) are applied to three sub pixels 7A of the pixel 7 of the liquid crystal panel 100A, and a signal voltage having maximum transmissivity of the signal voltages of red (R), green (G) and blue (B) applied to the three sub pixels 7A is applied to the pixel 7B of the liquid crystal panel 100B. In addition, if the voltage-transmission light intensity characteristic of the liquid crystal panel 100A and the voltage-transmission light intensity characteristic of the liquid crystal panel 100B are different, when a signal voltage in which the ratio of the transmission light intensity to the maximum transmission light intensity of the liquid crystal panel 100A becomes I is Vf1 and a signal voltage in which the ratio of the transmission light intensity to the maximum transmission light intensity of the liquid crystal panel 100B becomes I is Vf2, Vf1 and Vf2 are adjusted by Equation (1) such that the transmission light intensity ratio of the sub pixel 7A of the liquid crystal panel 100A and the transmission light intensity ratio of the pixel 7B of the liquid crystal panel 100B become I.

I[Vf1]=I[Vf2] (1)

In the first embodiment, when the transmission light intensity ratio of the sub pixel 7A of the liquid crystal panel 100A is larger than 0.1, a signal voltage in which the transmissivity of the pixel 7B becomes a maximum may be applied. The transmission light intensity ratio of 0.1 is an example of a “threshold value” of the invention. At this time, when the transmission light intensity ratio of the sub pixel 7A of the liquid crystal panel 100A is 0.1 or less, the signal voltage having the maximum transmission light intensity ratio of the signal voltages of red (R), green (G) and blue (B) applied to the three sub pixels 7A of the liquid crystal panel 100A is applied to the pixel 7B of the liquid crystal panel 100B. In addition, Vf1 and Vf2 may be adjusted by Equation 2 such that the transmission light intensity ratio of the sub pixel 7A of the liquid crystal panel 100A becomes 10% of I (0.1×I) and the transmission light intensity ratio of the pixel 7B of the liquid crystal panel 100B becomes I.

0.1×I[Vf1]=I[Vf2] (2)

FIG. 14 is a view showing a simulation result of contrast in a vertical direction of the liquid crystal panel. FIG. 15 is a view showing a simulation result of contrast in a horizontal direction of the liquid crystal panel. Next, the simulation of the contrast of the liquid crystal panel 100A (110B) will be described with reference to FIGS. 14 and 15.

As shown in FIG. 14, when the stand-alone liquid crystal layer 11A (11b) is used and when the liquid crystal layer 11A and the liquid crystal layer 11B corresponding to the first embodiment of the invention are overlapped, it is determined that the contrast is increased in all viewing angles when the liquid crystal layer 11A and the liquid crystal layer 11B are overlapped. For example, in a viewing angle of 0°, while the contrast is about 1.0×10³ in the stand-alone liquid crystal layer 11A (11B), the contrast is about 7.0×10⁵ when the liquid crystal layer 11A and the liquid crystal layer 11B.

As shown in FIG. 15, even in the contrast in the horizontal direction of the liquid crystal panel 100A (100B), it is determined that the contrast is increased in all viewing angles when the liquid crystal layer 11A and the liquid crystal layer 11B.

In the first embodiment, as described above, since the contrast corresponding to the product of the contrast of the liquid crystal panel 100A and the contrast of the liquid crystal panel 100B can be obtained by arranging the liquid crystal panel 100A and the liquid crystal panel 100B to overlap with each other, it is possible to increase the contrast of the liquid crystal display device 100, unlike a liquid crystal display device including only one liquid crystal panel. In addition, since the color filters 13 are provided on the surface of the liquid crystal panel 100A and the color filters 13 are not provided on the surface of the liquid crystal panel 100B, unlike a case where the color filters 13 are provided on both the liquid crystal panel 100A and the liquid crystal panel 100B, it is possible to suppress the darkening of an image when the liquid crystal panel 100A or the liquid crystal panel 100B is viewed from the front side thereof by the reduced number of color filters 13. In addition, since the pixel 7B of the liquid crystal panel 100B is provided with respect to the three sub pixels 7A of the liquid crystal panel 100A, it is possible to reduce deterioration of an aperture ratio due to displacement generated when the panel is viewed in an oblique direction.

In the first embodiment, as described above, since the color filters 13 of red (R), green (G) and blue (B) are provided in the plurality of sub pixels 7A by arranging one pixel 7B in every pixel 7 including the plurality of sub pixels 7A, it is possible to display a color image by an additive color mixture. In addition, it is possible to obtain the contrast corresponding to the product of the contrast of the pixel 7 and the contrast of the pixel 7B by arranging one pixel 7B in every pixel 7 including the plurality of sub pixels 7A.

In the first embodiment, as described above, since, of the signal voltages applied to the sub pixels 7A, the signal voltage having maximum transmissivity is applied to the pixel 7B by applying the signal voltage having maximum transmissivity of the signal voltages applied to the plurality of sub pixels 7A configuring the pixel 7 of the liquid crystal panel 100A to the pixel 7B of the liquid crystal panel 100B corresponding to the pixel 7 of the liquid crystal panel 100A, it is possible to further suppress the darkening of the image.

In the first embodiment, as described above, if the transmission light intensity ratio of the sub pixel 7A is more than 10% (0.1) of the maximum transmission light intensity, the signal voltage having a transmission light intensity ratio may be applied to the pixel 7B, and, if the transmission light intensity ratio of the sub pixel 7A is equal to or less than 10% (0.1) of the maximum transmission light intensity, a signal voltage having a transmission light intensity ratio of the signal voltages applied to the three sub pixels 7A may be applied to the pixel 7B. Accordingly, even when the transmission light intensity ratio of the sub pixel 7A is equal to or less than 10% of the maximum transmission light intensity, since the signal voltage having the transmission light intensity ratio corresponding to the sub pixel 7A having the maximum transmission light intensity is applied, it is possible to efficiently increase the contrast.

In the first embodiment, as described above, since the transmissivity is improved compared with a polarization plate having a polarization degree exceeding 99% by configuring the polarization plate 9, the polarization plate 15A and the polarization plate 15B such that the polarization degree of at least one of the polarization plats becomes 99% or less, it is possible to further suppress darkening of the image.

In the first embodiment, as described above, since the substrate 1A and the substrate 1B protrude compared with the liquid crystal layer 11A and the liquid crystal layer 11B in plan view and the polarization plate 9 is formed on the substantial whole surfaces of the substrate 1A and the substrate 1B, it is possible to easily increase mechanical strength when the substrate 1A, the substrate 1B and the polarization plate 9 are put together.

In the first embodiment, as described above, since the liquid crystal display device 100 of the FFS system can be formed by providing the pixel electrode 29A and the common electrode 31A on the surface of the substrate 1A at the side of the liquid crystal layer 11A and providing the pixel electrode 29B and the common electrode 31B on the surface of the substrate 1B at the side of the liquid crystal layer 11B, it is possible to increase the viewing angle. That is, since the electric field is applied to liquid crystal molecules in a lateral (oblique) direction in the FFS system, a variation of the liquid crystal molecules in a longitudinal direction does not occur unlike a system for applying an electric field in the longitudinal direction. Thus, it is possible to increase the viewing angle.

### Second Embodiment

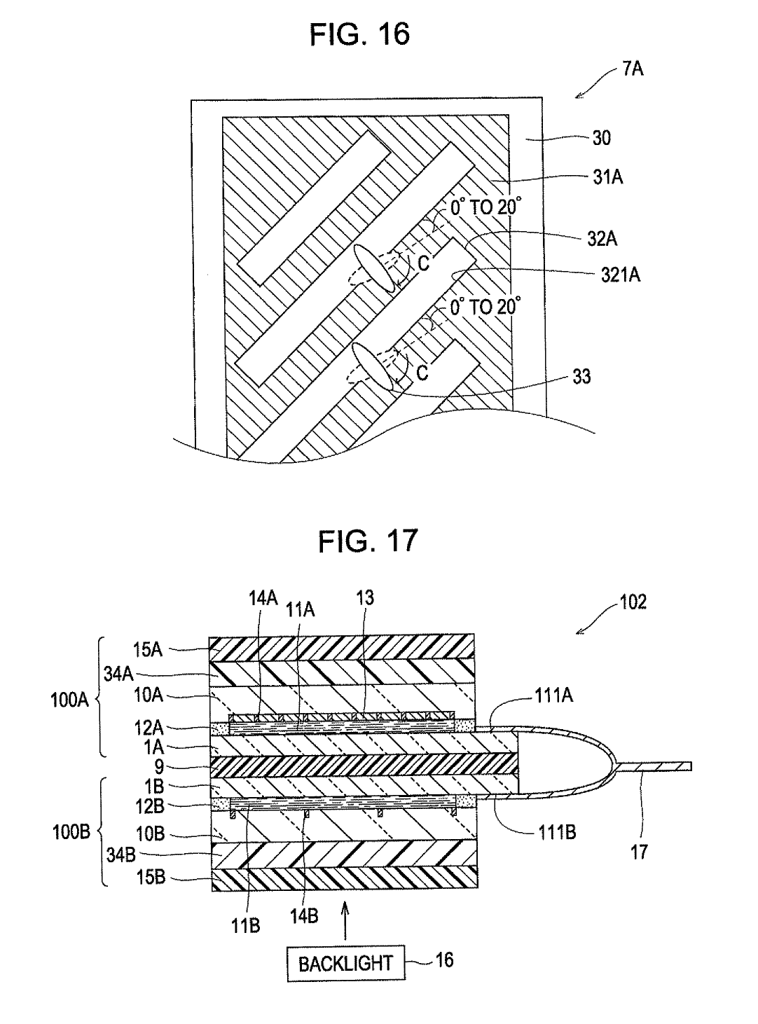

FIG. 16 is a plan view of a sub pixel of a liquid crystal display device according to a second embodiment of the invention. In the second embodiment, unlike the first embodiment, the liquid crystal display device 101 in which the rotation direction of the liquid crystal 33 of the liquid crystal panel 100A and the rotation direction of the liquid crystal 33 of the liquid crystal panel 100B are equal will be described with reference to FIGS. 10 and 16.

In the liquid crystal display device 101 according to the second embodiment, as shown in FIG. 16, the liquid crystal 33 of the liquid crystal panel 100A is aligned to form an angle 0° to 20° with the long side 321A of the slit 32A in a direction denoted by an arrow C (clockwise direction) when the voltage is not applied to the liquid crystal 33. Accordingly, when the voltage is applied to the liquid crystal 33 of the liquid crystal panel 100A, the liquid crystal 33 can be rotated in the direction denoted by the arrow C (clockwise direction), unlike the first embodiment shown in FIG. 10. In addition, the alignment of the liquid crystal 33 of the liquid crystal panel 100B is equal to the first embodiment shown in FIG. 10. By arranging the liquid crystal panel 100B to be reversed against the liquid crystal panel 100A, the rotation direction of the liquid crystal 33 of the liquid crystal panel 100A and the rotation direction of the liquid crystal 33 of the liquid crystal panel 100B are equal. In addition, the other configuration of the second embodiment is equal to that of the first embodiment.

The effects of the second embodiment are equal to those of the first embodiment.

### Third Embodiment

FIG. 17 is a cross-sectional view of a liquid crystal display device according to a third embodiment of the invention. In the third embodiment, unlike the first embodiment, the liquid crystal display device 102 in which C plates 34A and 34B are provided will be described with reference to FIGS. 8 and 17.

In the liquid crystal display device 102 according to the third embodiment, the C plate 34A is provided between the counter substrate 10A of the liquid crystal panel 100A and the polarization plate 15A. The C plate 34B is provided between the counter substrate 10B of the liquid crystal panel 100B and the polarization plate 15B. In addition, the C plate 34A (34B) is an example of a “first retardation film” of the invention. In addition, the polarization axis of light incident to the C plate and the polarization axis of light emitted from the C plate become equal. Accordingly, the relationship between the transmission axis of the polarization plate of the liquid crystal display device 102 and the rubbing direction is equal to that of the first embodiment shown in FIG. 8.

In the third embodiment, as described above, by providing the C plates 34A and 34B between the liquid crystal layer 11A and the polarization plate 15A and between the liquid crystal layer 11B and the polarization plate 15B, it is possible to easily increase the viewing angle by the C plates 34A and 34B.

The other effects of the third embodiment are equal to those of the first and second embodiments.

### Fourth Embodiment

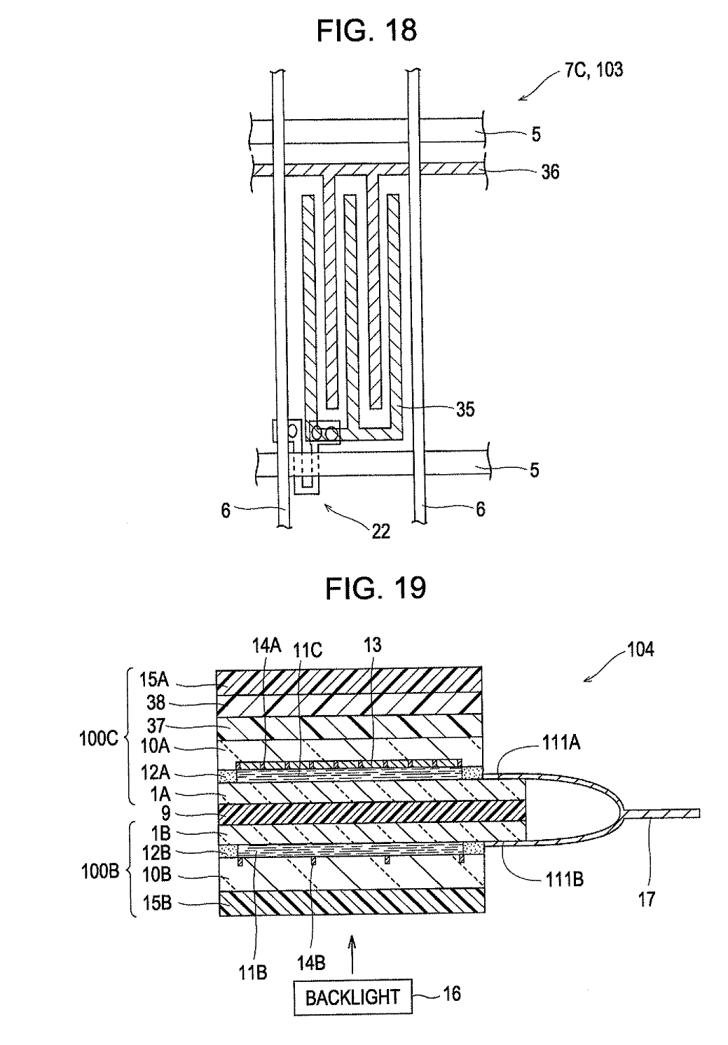

FIG. 18 is a plan view of a sub pixel of a liquid crystal display device according to a fourth embodiment of the invention. In the fourth embodiment, unlike the first to third embodiments, the liquid crystal display device 103 of an in-plane switching (IPS) system will be described with reference to FIG. 18.

In a sub pixel 7C of the liquid crystal display device 103 of the IPS system according to the fourth embodiment, a comb-like pixel electrode 35 and a comb-like common electrode 36 are arranged to face each other. In addition, the pixel electrode 35 is an example of a “first pixel electrode (second pixel electrode)” of the invention. The common electrode 36 is an example of a “first common electrode (second common electrode)” of the invention. The pixel electrode 35 is provided in every sub pixel 7C to be electrically connected to the drain region 23B (see FIG. 7) of the TFT 22. In addition, the common electrode 36 is commonly provided in all sub pixels 7C, to which a common potential COM is supplied from the driving IC 8 shown in FIG. 1. The other configuration of the fourth embodiment is equal to that of the first to third embodiments.

In the fourth embodiment, as described above, Since the liquid crystal display device 103 of the IPS system can be configured by forming the comb-like pixel electrode 35 and common electrode 36, it is possible to increase the viewing angle, unlike a system for applying an electric field in a longitudinal direction.

The other effects of the fourth embodiment are equal to those of the first to third embodiments.

### Fifth Embodiment

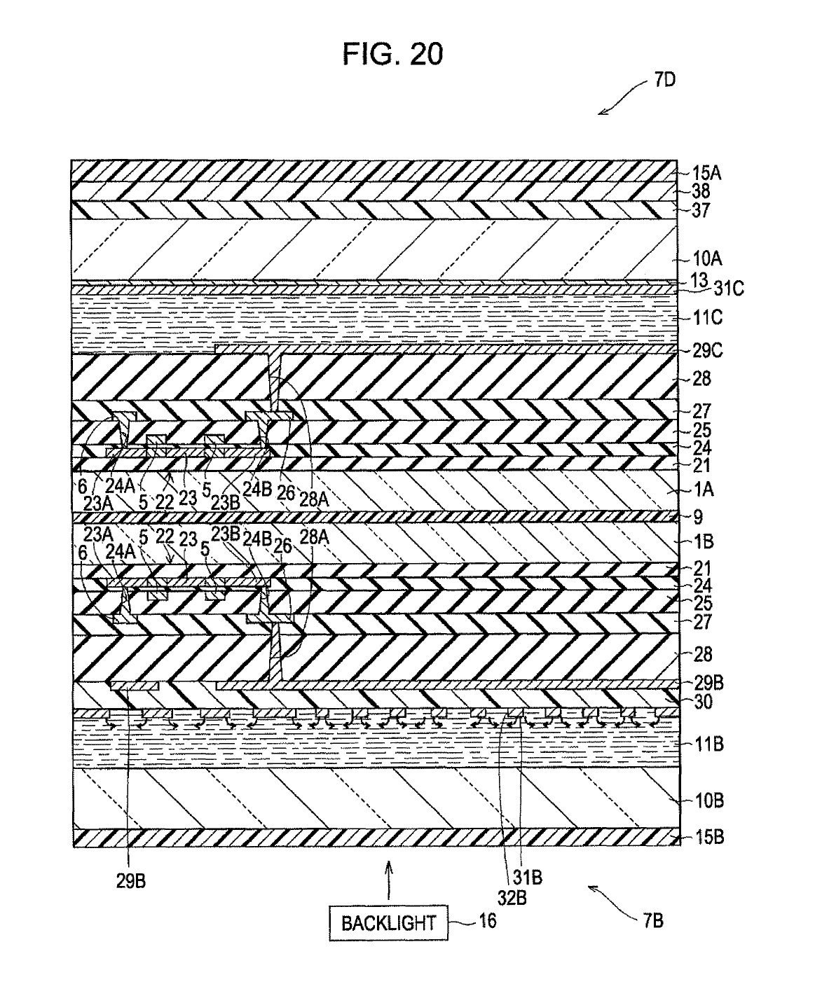

FIG. 19 is a cross-sectional view of a liquid crystal display device according to a fifth embodiment of the invention. FIG. 20 is a detailed cross-sectional view of the liquid crystal display device according to the fifth embodiment of the invention. In the fifth embodiment, unlike the first embodiment, the liquid crystal display device 104 in which liquid crystal of a liquid crystal layer 11C is OCB liquid crystal will be described with reference to FIGS. 19 and 20.

In the liquid crystal display device 104 according to the fifth embodiment, an A plate 37 having a thickness of about 50 nm to about 100 nm is formed on the surface of the counter substrate 10A of the liquid crystal panel 10C. In addition, the A plate 37 is an example of a “first retardation film” of the invention. In addition, the polarization axis of the A plate is −45°. According to the kind of the liquid crystal, the A plate may not be included and the polarization axis of the A plate may be 450. A WV (Wide View) film 38 is formed on the surface of the A plate 37. Accordingly, it is possible to increase the viewing angle of the liquid crystal display device 104.

The liquid crystal of the liquid crystal layer 11C is OCB (Optically Compensated Bend) liquid crystal in which the molecules constituting the liquid crystal are arranged in a bow form after a voltage for phase-transitioning the liquid crystal is applied, unlike the first embodiment. The liquid crystal layer 11C is an example of a “first liquid crystal layer” of the invention.

Next, the detailed configuration of the sub pixel 7D according to the fifth embodiment of the invention will be described with reference to FIG. 20. In addition, in the fifth embodiment of the invention, like the first embodiment, one pixel 7B is arranged with respect to three sub pixels 7D.

As shown in FIG. 20, a pixel electrode 29C which becomes a transparent electrode such as ITO is formed on the surface of the planarization film 28. The counter substrate 10A is provided to face the pixel electrode 29C. In the fifth embodiment, the color filters 13 are formed on the surface of the counter substrate 10A at the side of the pixel electrode 29C and the common electrode 31C is formed on the surface of the color filters 13. The common electrode 31C is an example of a “first common electrode” of the invention. In addition, the A plate 37, the WV film 38 and the polarization plate 15A are laminated on the surface of the counter substrate 10A at the side opposite to the pixel electrode 29C. The liquid crystal layer 11C formed of the OCB liquid crystal is formed between the pixel electrode 29C and the common electrode 31C. The other configuration of the sub pixel 7D is equal to that of the first embodiment shown in FIG. 7. The detailed configuration of the pixel 7B is equal to that of the first embodiment shown in FIG. 7.

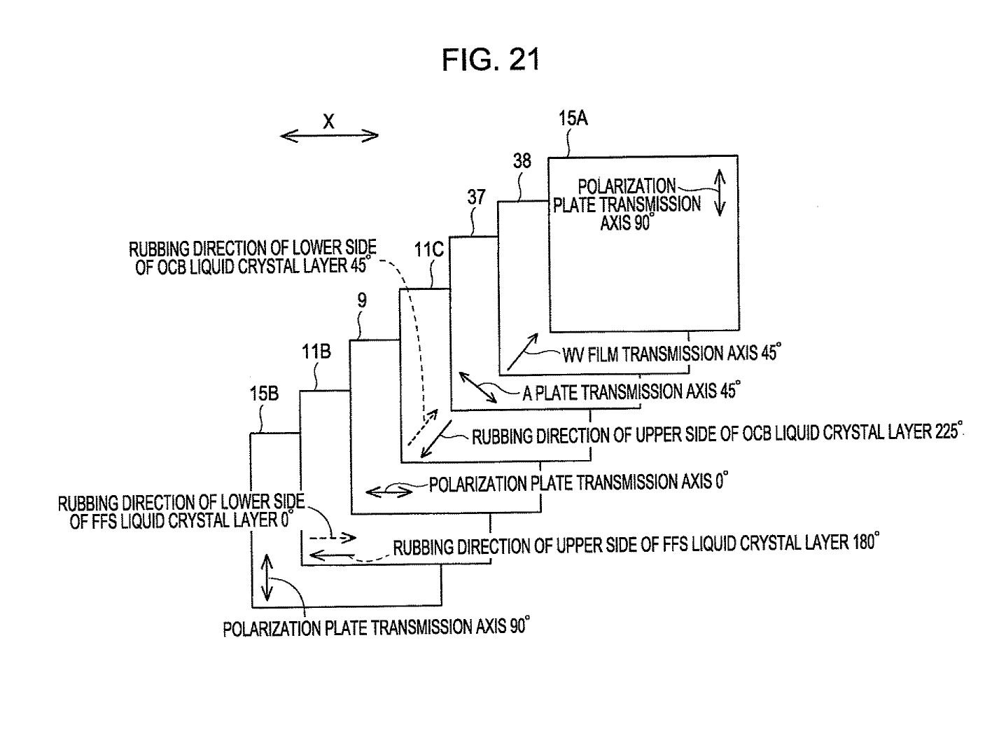

FIG. 21 is a view explaining a transmission axis of a polarization plate and a rubbing direction of an alignment film of the liquid crystal display device according to the fifth embodiment of the invention. Next, the direction of the transmission axis of the polarization plate and the rubbing direction of the liquid crystal layer (alignment film) of the liquid crystal display device 104 will be described with reference to FIG. 21.

As shown in FIG. 21, the transmission axis of the polarization plate 15A provided on the surface of the WV film 38 forms 90° with the X direction. The transmission axis of the WV film 38 is 45°. The transmission axis of the A plate 37 is −45°. The rubbing angles of one (upper side) and the other (lower side) of the alignment films provided with the liquid crystal layer 11C interposed therebetween are 225° and 45°, respectively. The transmission axis of the polarization plate 9 becomes 0° to be perpendicular to the transmission axis of the polarization plate 15A. The rubbing angles of one (upper side) and the other (lower side) of the alignment films provided with the liquid crystal layer 11B interposed therebetween are 180° and 0°, respectively. The transmission axis of the polarization plate 15B becomes 90° to be perpendicular to the transmission axis of the polarization plate 9.

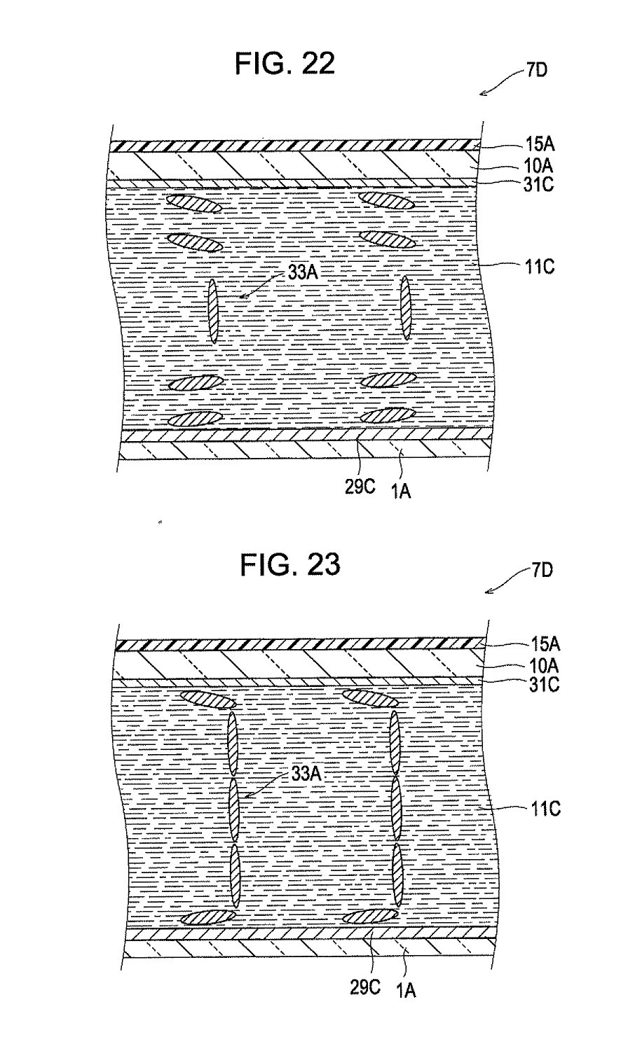

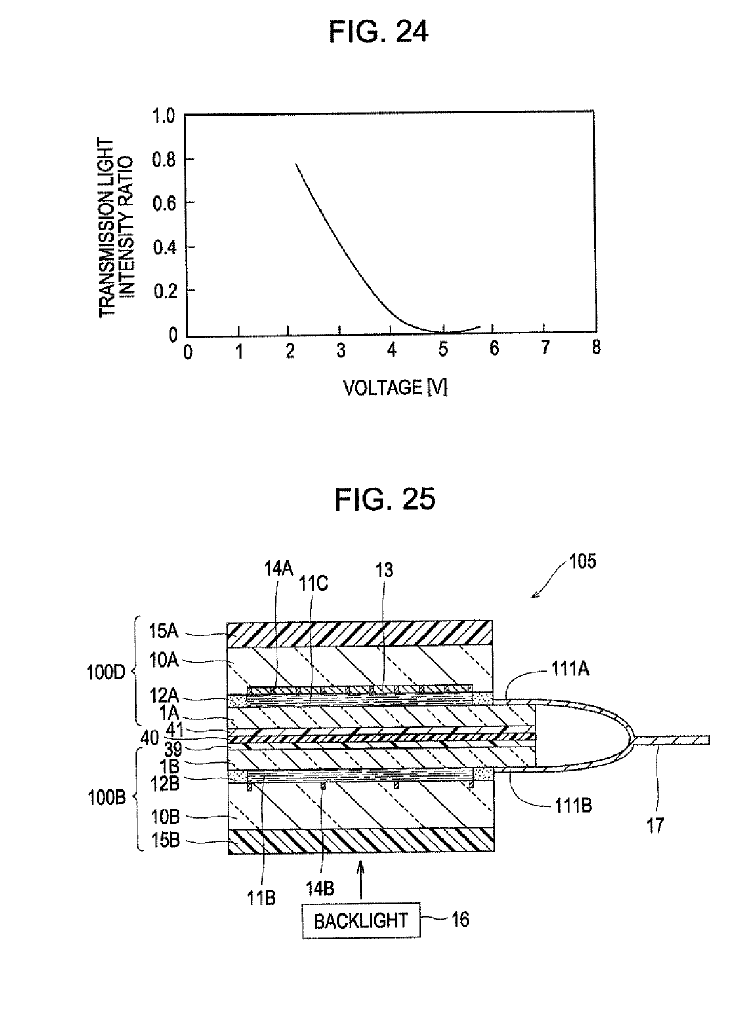

FIGS. 22 and 23 are cross-sectional views of a sub pixel for explaining the operation of OCB liquid crystal according to the fifth embodiment of the invention. FIG. 24 is a view showing a relationship between an applied voltage and a transmission light intensity ratio according to the fifth embodiment of the invention. Next, the operation of the liquid crystal display device 104 according to the fifth embodiment of the invention will be described with reference to FIGS. 22 to 24. FIGS. 22 and 23 show only the substrate 1A, the pixel electrode 29C, the common electrode 31C, the counter substrate 10A, the polarization plate 15A and the liquid crystal 33A, because the configuration of the sub pixel 7D is simplified.

In the OCB liquid crystal, as shown in FIG. 22, unlike the FFS system, the pixel electrode 29C and the common electrode 31C face each other with the liquid crystal layer 11C. In the OCB liquid crystal, the voltage having a phase transition threshold value or more is applied to the liquid crystal 33A, and the liquid crystal 33A is changed from a spray state (not shown) to a bend state shown in FIG. 22. In the bend state shown in FIG. 22, the liquid crystal 33A in the vicinity of a central portion of the thickness direction of the liquid crystal layer 11C is aligned in a direction substantially vertical to a direction in which the pixel electrode 29C extends, and the liquid crystal in a region excluding the vicinity of the central portion of the liquid crystal layer 11C is aligned in a direction substantially horizontal to the pixel electrode 29C. In the liquid crystal 33A shown in FIG. 22, the light incident to the liquid crystal layer 11C from the lower side thereof is emitted such that a white display is performed.

Next, when a voltage (about 5 V, in the example of FIG. 24) corresponding to a black display is applied to the liquid crystal 33A, as shown in FIG. 23, the liquid crystal 33A is aligned in the direction substantially vertical to the direction in which the pixel electrode 29C extends, in a region excluding the vicinity of the pixel electrode 29C and the vicinity of the common electrode 31C. That is, the entire liquid crystal 33A is aligned in a bow form. As a result, the liquid crystal display device 104 performs the black display. In addition, the liquid crystal 33 (see FIG. 11) of the liquid crystal layer 11B is driven by the FFS system, like the first embodiment.

Next, the relationship between the voltage applied to the pixel 7 of the liquid crystal panel 100C and the voltage applied to the pixel 7 of the liquid crystal panel 100B will be described.

In the liquid crystal display device 104, when the transmission light intensity ratio of the pixel 7 of the liquid crystal panel 100C is more than 0.1, a signal voltage having a maximum transmission light intensity ratio is applied to the pixel 7B of the liquid crystal panel 100B. In addition, when the transmission light intensity ratio of the pixel 7 of the liquid crystal panel 100C is equal to or less than 0.1, a signal voltage having a maximum transmission light intensity ratio of the signal voltages applied to the three sub pixels 7D of the liquid crystal panel 10C is applied. When the signal voltage of which a transmission light intensity ratio to the maximum transmission light intensity of the liquid crystal panel 100C becomes I is Vo and the signal voltage of which a transmission light intensity ratio to the maximum transmission light intensity of the liquid crystal panel 100B becomes I is Vf2, Vo and vf2 may be adjusted like Equation (3) such that the transmission light intensity ratio of the pixel 7 of the liquid crystal panel 100C becomes 10% of I (0.1×I) and the transmission light intensity ratio of the pixel 7B of the liquid crystal panel 100B becomes I.

0.1×I[Vo]=I[Vf2] (3)

the fifth embodiment, as described above, by providing the pixel electrode 29C on the surface of the substrate 1A at the side of the liquid crystal layer 11C and providing the common electrode 31C on the surface of the counter substrate 10A so as to face the pixel electrode 29C with the liquid crystal layer 11C interposed therebetween, the liquid crystal 33A included in the liquid crystal layer 11C becomes the OCB liquid crystal. Accordingly, since a variation in the alignment of the liquid crystal molecules is accelerated by the bow form in the OCB liquid crystal, it is possible to configure a liquid crystal display device 104 having a rapid response speed.

In the fifth embodiment, as described above, providing the A plate 37 between the liquid crystal layer 11C and the polarization plate 15A, it is possible to easily increase the viewing angle of the liquid crystal display device 104 by the A plate 37.

The other effects of the fifth embodiment are equal to those of the first embodiment.

### Sixth Embodiment

FIG. 25 is a cross-sectional view of a liquid crystal display device according to a sixth embodiment of the invention. In the sixth embodiment, unlike the first embodiment, the liquid crystal display device 105 in which a polarization plate 39, a ½ wavelength plate 40 and a polarization plate 41 are interposed between the substrate 1A and the substrate 1B will be described with reference to FIG. 25.

In the liquid crystal display device 105 according to the sixth embodiment, the polarization plate 39 is formed on the surface of the substrate 1B. In the sixth embodiment, the ½ wavelength plate 40 is formed on the surface of the polarization plate 39. The ½ wavelength plate 40 is an example of a “second retardation film” of the invention. The ½ wavelength plate 40 has a function for rotating the polarization axis of incident light by (180°-2θ) when the polarization axis of the ½ wavelength plate 40 forms an angle θ with the polarization axis of incident light. The polarization plate 41 is formed on the surface of the ½ wavelength plate 40. In the sixth embodiment, the transmission axes of the polarization plate 39 and the polarization plates 41 form about 45°, and the ½ wavelength plate 40 rotates the polarization of the light incident from one of a pair of polarization plate 39 and polarization plate 41 by 45° and emits the light to the other polarization plate. In addition, the liquid crystal of the liquid crystal layer 11C according to the sixth embodiment is the OCB liquid similar to the fifth embodiment. The other configuration of the sixth embodiment is similar to that of the first embodiment.

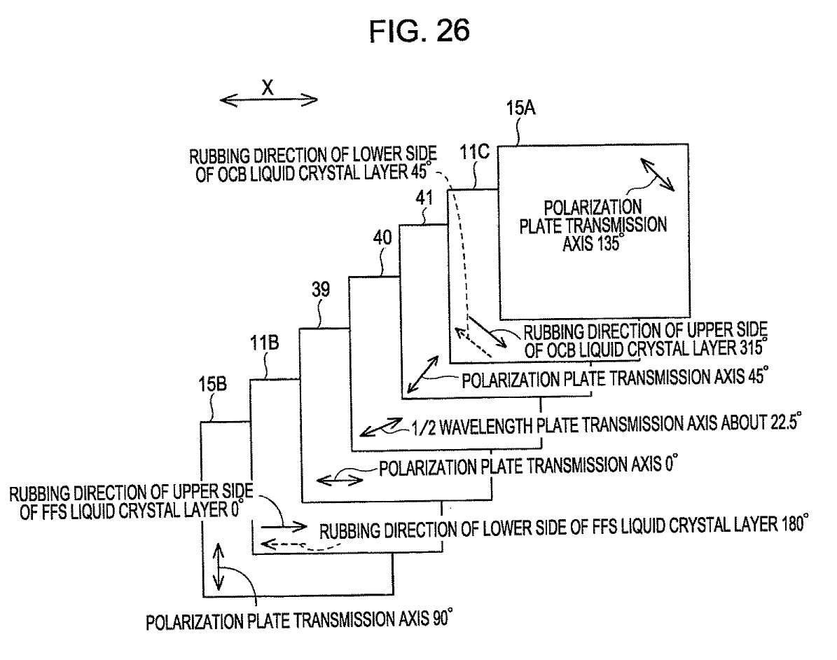

FIG. 26 is a view explaining a transmission axis of a polarization plate and a rubbing direction of an alignment film of the liquid crystal display device according to the sixth embodiment of the invention. Next, the direction of the transmission axis of the polarization plate and the rubbing direction of the liquid crystal layer (alignment film) of the liquid crystal display device 105 will be described with reference to FIG. 26.

As shown in FIG. 26, the transmission axis of the polarization plate 15A provided on the surface of the liquid crystal layer 11C forms 135° with the X direction. The rubbing angles of one (upper side) and the other (lower side) of the alignment films provided with the liquid crystal layer 11C interposed therebetween are 315° and 45°, respectively. The transmission axis of the polarization plate 41 is 45° to be perpendicular to the transmission axis of the polarization plate 15A. The transmission axis of the ½ wavelength plate 40 becomes about 22.5°. The transmission axis of the polarization plate 39 becomes 0°. The rubbing angles of one (upper side) and the other (lower side) of the alignment films provided with the liquid crystal layer 11B interposed therebetween are 0° and 180°, respectively. The transmission axis of the polarization plate 15B becomes 90°.

In addition, the other configuration of the sixth embodiment is equal to that of the first embodiment.

In the sixth embodiment, as described above, by including the pair of polarization plates 39 and 41 interposed between the substrate 1A and the substrate 1B and the ½ wavelength plate 40 interposed between the pair of polarization plates 39 and 41, it is possible to separately set the polarization axes of the pair of polarization plates 39 and 41 and adjust a viewing angle.

In the sixth embodiment, as described above, by arranging the ½ wavelength plate 40 between the pair of polarization plates 39 and 41, it is possible to change the polarization axis of the light incident from the polarization plate 39 to the ½ wavelength plate 40 to a desired polarization axis such that the light is emitted to the polarization plate 41.

In the sixth embodiment, as described above, since the transmission axes of the polarization plate 39 and the polarization plate 41 form about 45°, and the ½ wavelength plate 40 rotates the polarization of the light incident from one of the pair of polarization plate 39 and polarization plate 41 by 45° and emits the light to the other polarization plate, it is possible to increase the viewing angle over omnidirection.

### Seventh Embodiment

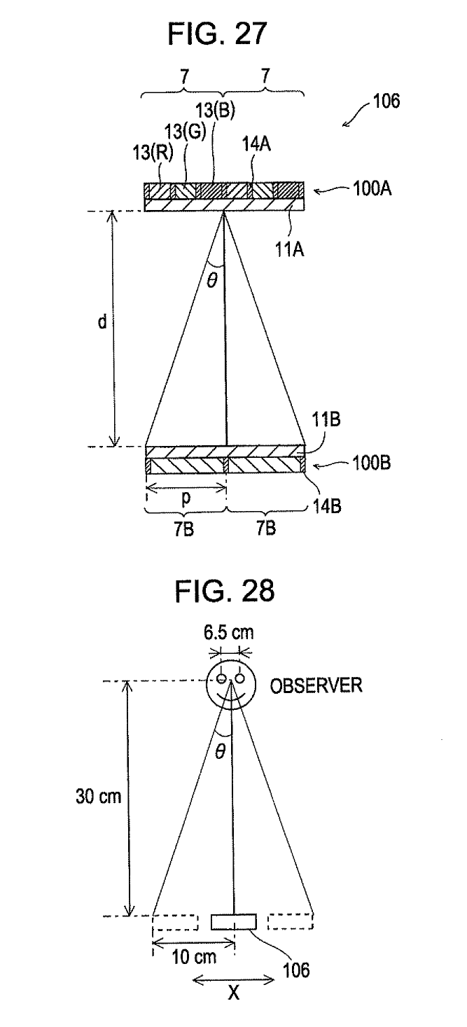

FIG. 27 is a view showing a positional relationship between two liquid crystal panels according to a seventh embodiment of the invention. FIG. 28 is a view explaining a positional relationship between an observer and the liquid crystal display device according to the seventh embodiment of the invention. In the seventh embodiment, the liquid crystal display device 106 in which a distance d between the two liquid crystal layers 11A and 11B is defined will be described with reference to FIGS. 27 and 28.

In the liquid crystal display device 106 according to the seventh embodiment, as shown in FIG. 27, the liquid crystal panel 100A (liquid crystal layer 11A) and the liquid crystal panel 100B (liquid crystal layer 11) are arranged at an interval of the distance d. In the seventh embodiment, the liquid crystal panel 100A and the liquid crystal panel 100B are arranged so as to satisfy Equation

d≦p/0.33 (1)

where, p denotes the pixel pitch of the pixel 7B of the liquid crystal panel 100B. Equation (1) is derived as follows.

As shown in FIG. 28, in the portable liquid crystal display device 106 to be used by an observer while being held in a hand, the observer views the liquid crystal display device 106 at a distance of about 30 to about 50 cm. Since a difficult condition appears as the distance between the observer and the liquid crystal display device 106 is decreased, the distance is 30 cm. It is assumed that the liquid crystal display device 106 is portable and is held by the observer in a hand. It is assumed that the observer may hold the liquid crystal display device 106 in a right hand or a left hand, and the liquid crystal display device is moved by 10 cm as a maximum in a direction denoted by an arrow X when it is held in the right hand and left hand. At this time, when the liquid crystal display device 106 is held in the right hand and the left hand, the liquid crystal display device 106 is shifted from the central line of both eyes of the observer by an angle θ. This angle θ is expressed by Equation (2).

θ=ATAN(10/30) (2)

where, ATAN denotes an arc tangent.

When the observer views the liquid crystal display device 106 from the side of the liquid crystal panel 100A shown in FIG. 27 and the observer holds the liquid crystal display device 106 in the right hand and the left hand, in order to observe the light passing through the pixel 7B of the liquid crystal panel 100B facing a predetermined pixel 7 via the predetermined pixel 7 of the liquid crystal panel 100A, the distance d between the liquid crystal layer 11A and the liquid crystal layer 11B needs to satisfy Equation (3).

d≦p/tan θ (3)

From Equation (2), since tan θ=10/30 (=about 0.33), Equation (1) can be obtained. More particularly, a gap between both eyes of the observer is about 6.5 cm. When the liquid crystal display device 106 shifted to a right side is viewed by a left eye or when the liquid crystal display device 106 shifted to the left side is viewed by a right eye, the distance from the center of both eyes to the left eye (right eye) (6.5/2 cm) is added to the shift (10 cm) of the liquid crystal display device 106, and thus tan θ=(10+3.25)/30 (about 0.44) is obtained. The distance d between the liquid crystal layer 11A and the liquid crystal layer 11B needs to satisfy Equation (4).

d≦p/0.44 (4)

In addition, the other configuration of the seventh embodiment is equal to that of the first embodiment.

In the seventh embodiment, as described above, if the distance d between the liquid crystal layer 11A and the liquid crystal layer 11B is configured to satisfy a relationship of d≦p/0.33 when the pixel pitch of the pixel 73 is p, when the predetermined pixel 7 of the liquid crystal panel 100A is viewed in an oblique direction, it is possible to suppress leakage of the light from the pixel 73 adjacent to the pixel 7B of the liquid crystal panel 100B corresponding to the predetermined pixel 7 from the predetermined pixel 7 of the liquid crystal panel 100A.

In the seventh embodiment, as described above, if the distance d between the liquid crystal layer 11A and the liquid crystal layer 113 is configured to satisfy a relationship of d≦p/0.44, even when the liquid crystal panel 100A shifted in the left (right) direction is viewed by the right eye (left eye) of the observer, it is possible to suppress leakage of the light from the pixel 7B adjacent to the pixel 7B of the liquid crystal panel 100B corresponding to the predetermined pixel 7 from the predetermined pixel 7 of the liquid crystal panel 10A.

The other effects of the seventh embodiment are equal to those of the first embodiment.

The disclosed embodiments are only exemplary and the invention is not limited to them. The range of the invention is not described in the above-described embodiments, but is described in the claims, and all modifications are included in the range of the claims and equivalents thereof.

For example, although one pixel 7B of the liquid crystal panel 100B is arranged in correspondence with three sub pixels 7A (7C, 7D) of the pixel 7 of the liquid crystal panel 100A in the first to seventh embodiments, the invention is not limited to this, and two or four or more sub pixels 7A (7C, 7D) of the pixel 7 of the liquid crystal panel 100A may be arranged.

Although the color filters 13 of red (R) green (G) and blue (B) are used in the first to seventh embodiments, the invention is not limited to this and color filters of cyan, magenta and yellow may be used or color filters of two or four or more colors may be used.

Although the threshold value for changing the signal voltage applied to the pixel 73 of the liquid crystal panel 100B is set to a value for making the transmission light intensity ratio become 0.1, the invention is not limited to this, and the threshold value may be set to a value for making the transmission light intensity ratio become a value other than 0.1.

The entire disclosure of Japanese Patent Application No. 2008-147788, filed Jun. 5, 2008 is expressly incorporated by reference herein.

What is claimed is:

1. A liquid crystal display device comprising:
a first liquid crystal panel including a first liquid crystal layer;
a second liquid crystal panel arranged to overlap the first liquid crystal panel and including a second liquid crystal layer; and
color filters provided on the first liquid crystal panel,
wherein color filters are not provided on the second liquid crystal panel,
the first liquid crystal panel includes a plurality of first pixels,
the second liquid crystal panel includes a plurality of second pixels,
each of the first pixels of the first liquid crystal panel includes a plurality of sub pixels, and
the second pixels are provided such that one second pixel corresponds to the plurality of sub pixels.

2. The liquid crystal display device according to claim 1, wherein one second pixel is arranged in correspondence with each first pixel including the plurality of sub pixels.

3. The liquid crystal display device according to claim 2, wherein, among signal voltages applied to the plurality of sub pixels configuring each of the first pixels of the first liquid crystal panel, a signal voltage having maximum transmissivity is applied to the second pixel of the second liquid crystal panel corresponding to each of the first pixels of the first liquid crystal panel.

4. The liquid crystal display device according to claim 3, wherein, if the transmissivity of the sub pixel having maximum transmissivity of the plurality of sub pixels configuring each of the first pixels is more than a predetermined threshold value, a signal voltage having maximum transmissivity is applied to the second pixel corresponding to each of the first pixels, and
if the transmissivity of the sub pixel having maximum transmissivity of the plurality of sub pixels configuring each of the first pixels is equal to or less than the predetermined threshold value, a signal voltage having transmissivity corresponding to a sub pixel having maximum transmissivity of the sub pixels configuring each of the first pixels is applied to the second pixel corresponding to each of the first pixels.

5. The liquid crystal display device according to claim 1, further comprising:
a first polarization plate interposed between the first liquid crystal layer and the second liquid crystal layer;
a second polarization plate provided on the surface of the first liquid crystal layer at side opposite to the first polarization plate side; and
a third polarization plate provided on the surface of the second liquid crystal layer at side opposite to the first polarization plate side,
wherein a polarization degree of at least one of the first polarization plate, the second polarization plate and the third polarization plate is 99% or less.

6. The liquid crystal display device according to claim 5, wherein a first retardation film is disposed in at least one of spaces between the first liquid crystal layer and the second polarization plate and between the second liquid crystal layer and the third polarization plate.

7. The liquid crystal display device according to claim 5, further comprising:
a first substrate interposed between the first liquid crystal layer and the first polarization plate; and
a second substrate interposed between the second liquid crystal layer and the first polarization plate,
wherein the first substrate and the second substrate protrude from the first liquid crystal layer and the second liquid crystal layer in plan view, and
the first polarization plate is formed on the substantially whole surfaces of the first substrate and the second substrate.

8. The liquid crystal display device according to claim 5, wherein the first polarization plate includes a pair of polarization plates and a second retardation film interposed between the pair of polarization plates.

9. The liquid crystal display device according to claim 8, wherein the second retardation film is a ½ wavelength plate.

10. The liquid crystal display device according to claim 9, wherein the polarization axes of the pair of polarization plates form an angle of 45° with each other, and the second retardation film rotates the polarization of light incident from one of the pair of polarization plates by 45° and emits the light to the other polarization plate.

11. The liquid crystal display device according to claim 1, further comprising:
a first polarization plate provided between the first liquid crystal layer and the second liquid crystal layer;
a first substrate provided between the first liquid crystal layer and the first polarization plate; and
a second substrate provided between the second liquid crystal layer and the first polarization plate,
wherein a first pixel electrode and a common electrode are provided on the surface of the first substrate at the first liquid crystal layer side, and
a second pixel electrode and a second common electrode are provided on the surface of the second substrate at the second liquid crystal layer side.

12. The liquid crystal display device according to claim 1, further comprising:
a first polarization plate provided between the first liquid crystal layer and the second liquid crystal layer;
a first substrate provided between the first liquid crystal layer and the first polarization plate;
a first counter substrate disposed to face the first substrate;
a second substrate provided between the second liquid crystal layer and the first polarization plate; and
a second counter substrate disposed to face the second substrate,
wherein a first pixel electrode is provided on the surface of the first substrate at the first liquid crystal layer side, and a first common electrode is provided on the surface of the first counter substrate to face the first pixel electrode with the first liquid crystal layer interposed therebetween, and
a second pixel electrode and a second common electrode are provided on the surface of the second substrate at the second liquid crystal layer side.

13. The liquid crystal display device according to claim 1, wherein a distance d between the first liquid crystal layer and the second liquid crystal layer is configured to satisfy a relationship of d≦p/0.33 when a pixel pitch of the second pixels is p.

14. The liquid crystal display device according to claim 13, wherein the distance d between the first liquid crystal layer and the second liquid crystal layer is configured to satisfy a relationship of d≦p/0.44.

15. A liquid crystal display device comprising:
a first liquid crystal panel including a first liquid crystal layer;
a second liquid crystal panel arranged to overlap the first liquid crystal panel and including a second liquid crystal layer; and
color filters provided on the first liquid crystal panel,
wherein color filters are not provided on the second liquid crystal panel,
the first liquid crystal panel includes a plurality of first pixels,
the second liquid crystal panel includes a plurality of second pixels,
the second pixels are provided in correspondence with the first pixels, and
a distance d between the first liquid crystal layer and the second liquid crystal layer is configured to satisfy a relationship of d≦p/0.33 when a pixel pitch of the second pixels is p.

16. The liquid crystal display device according to claim 15, wherein the distance d between the first liquid crystal layer and the second liquid crystal layer is configured to satisfy a relationship of d≦p/0.44.
